(19) United States
(12) Patent Application Publication
(10) Pub. No.: US 2024/0234779 A1
(43) Pub. Date: Jul. 11, 2024

(54) Rechargeable Benthic Microbial Fuel Cell

(71) Applicant: The Government of the United States of America, as represented by the Secretary of the Navy, Arlington, VA (US)

(72) Inventors: Leonard M. Tender, Bethesda, MD (US); Ian Martens, New Orleans, LA (US); Joel Wesson, Picayune, MS (US); Joel P. Golden, Fort Washington, MD (US); Jeffrey M. Book, Slidell, LA (US); Andrew Quaid, New Orleans, LA (US)

(21) Appl. No.: 18/403,796

(22) Filed: Jan. 4, 2024

Related U.S. Application Data
(60) Provisional application No. 63/438,062, filed on Jan. 10, 2023.

(51) Int. Cl. H01M 8/16; B63B 22/02

(52) U.S. Cl. CPC H01M 8/16; B63B 22/02; H01M 2250/10

(57) ABSTRACT

A benthic microbial fuel cell device (BMFC), namely an anode in contact with organic matter on the seafloor and a cathode in contact with overlying seawater, creates a closed path through which electric current can flow. In a conventional such device, it is used solely as a power source. However the application of a reverse voltage (for example, via solar power) results in storage of energy associated with the BMFC.

### CROSS-REFERENCE TO RELATED APPLICATIONS

This application claims the benefit of U.S. Provisional Patent Application No. 63/438,062 filed Jan. 10, 2023, the entirety of which is incorporated herein by reference.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, DC 20375, USA; +1.202.767.7230; techtran@nrl.navy.mil, referencing NC 211301.

### BACKGROUND

Various devices have been developed for persistent undersea power generation, including “Benthic Microbial Fuel Cell Equipped with a Pliable, Non-Compacting, High Surface Area Anode,” U.S. Provisional Patent Application No. 63/304,135 filed Jan. 28, 2022; “Remotely-Deployed Benthic Microbial Fuel Cell,” U.S. Pat. No. 10,644,341; “Method and Apparatus for Generating Electrical Power Using Sunlight and Microorganisms,” U.S. Pat. Nos. and 10,396,386 and 9,531,027; “Method and Apparatus for Generating Power From Voltage Gradients at Sediment-Water Interfaces Using Active Transport of Sediment Porewater,” U.S. Pat. No. 8,148,019; “Advanced Apparatus for Generating Electrical Power from Aquatic Sediment/Water Interfaces,” U.S. Pat. No. 8,012,616; “Apparatus Equipped with a Metallic Manganese Anode for Generating Power form Voltage Gradients at the Sediment-Water Interface,” U.S. Pat. No. 7,550,224; and “Method and Apparatus for Generating Power from Voltage Gradients at Sediment-Water Interfaces,” U.S. Pat. No. 6,913,854, each of which is incorporated herein by reference for the purposes of disclosing techniques for power generation involving at least partially submerged fuel cells.

The above-referenced documents describe forms of a benthic microbial fuel cell (BMFC), also referred to as a sediment microbial fuel cell. A BMFC has two primary components: a non-corrosive anode and cathode. Both frequently comprise graphite. Electrical power is generated by oxidizing organic matter (fuel) residing in the sediment at the buried anode and reducing oxygen at the cathode in the overlying water. The anode is atop of or fully or partially embedded in the marine sediment near the benthic interface, and is connected via external circuitry to the cathode, which is suspended in the overlying water. Bacterial biofilms that spontaneously form on the electrode surfaces catalyze the oxidation reaction occurring at the anode and the reduction reaction occurring at the cathode. Electrical current flows from the anode through the external circuit to the cathode. The necessary balance of charge is facilitated by a concomitant flow of protons from the anode through the sediment and water to the cathode, where the protons are generated as a byproduct of the bacterial-catalyzed oxidation of organic matter and consumed by the bacterial-catalyzed reduction of oxygen.

In order for the BMFC to operate, the anode should be isolated from oxygen in overlying water but exposed to sediment pore water. This can be achieved by completely embedding the anode below the sediment surface (see, e.g., U.S. Pat. No. 6,913,854); by placing the anode on top of the sediment surface and/or pressing it into the sediment without completely embedding it beneath the sediment surface while covering the anode with a physical barrier preventing its direct exposure to overlying water (see, e.g., U.S. Pat. No. 10,644,341); or by enclosing the anode in a chamber that is accessible to sediment pore water and not overlying water (see, e.g., U.S. Pat. No. 8,012,616).

Like other batteries and fuel cells, a BMFC is characterized by an open circuit cell voltage representing the difference in potential energy of electrons at the cathode versus the potential energy of electrons at the anode when no current is flowing (namely when the cathode and anode are not connected through an external circuit, also referred to as “open circuit”). For a BMFC, the open circuit cell voltage is typically between 0.6 and 0.85 V depending on the location deployed. Moreover, like other batteries and fuel cells, when the anode and cathode are connected through an external circuit (e.g., an electrical power consuming instrument) so that electrical current flows from the anode through the circuit to the cathode, the operating cell voltage decreases from the open cell voltage. Also like other batteries and fuel cells, as resistance of the external circuit is decreased, current generated by the BMFC increases and the operating cell voltage decreases. As power is the product of current and the operating cell voltage, there is an operating cell voltage at which power output is maximized. For the BMFC this is typically 0.35-0.45 V.

The electrode material of choice for both the BMFC anode and the cathode is graphite owing to the nature of the microbial/electrode electron transfer processes underpinning the BMFC operation, and because graphite resists corrosion in the marine environment.

In this configuration, such devices have been shown to be capable of persistent power generation sufficient for recharging batteries, allowing for long term operation of marine-deployed electronic devices. Due to the self-repairing nature of its living electrode catalysts, and the ongoing supply of the electrode reactants (organic matter and oxygen) in marine environments by natural process including diffusion and advection from for example, tidal pumping, a BMFC can provide persistent battery-level power for long-term uninterrupted operation of low-power systems that are otherwise limited in lifetime by battery depletion. Marine sediment is a water-saturated particle matrix and the BMFC fuel, the organic matter residing in the pore water or marine sediment, derives from multiple sources including sedimentation of phytoplankton detritus. The BMFC oxidant, oxygen in the overlying water, derives from multiple sources including photosynthetic plankton.

Power output of the BMFC is limited by the rate of mass transport at which organic matter in sediment pore water is supplied to the anode biofilm by diffusion and advection. As such, the power output of the BMFC depends on the specific site at which it is deployed as differences in sediment composition affect the amount and mass transport of organic matter in sediment pore water. At a given site, power generated by the BMFC scales with the amount of anode surface area that is accessible to mass transport of sediment organic matter. Thus one desires a high mass transport accessible surface area anode, namely an anode having a large anode/sediment interfacial surface area, where, ideally, each surface area element does not compete with other surface area elements with respect to mass transport of sediment organic matter. See, e.g., U.S. Provisional Patent Application No. 63/304,135 filed Jan. 28, 2022.

A need exists for improved power generation from BMFCs.

### BRIEF SUMMARY

In one embodiment, a BMFC comprises an anode electrode assembly in contact with aquatic sediment; a cathode electrode in seawater above the sediment; a rig for maintaining relative positions of the anode electrode assembly and the cathode electrode; electrical leads extending from the anode electrode assembly and the cathode electrode; and a power source operably connected to the leads and configured to apply a voltage causing electrons to flow from the cathode to the anode, thereby resulting in the storage of energy associated with the BMFC, wherein the power source obtains energy via solar power source, wind power, and/or wave power.

In another embodiment, a method of using a BMFC of the first embodiment involves storing power in the BMFC with the energy source and then allowing the BMFC to discharge.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A depicts a previously-described configuration of a BMFC where the symbol noted with an asterisk represents a power-consuming system. FIG. 1B shows a configuration according to the invention wherein application of reverse voltage greater than the open circuit cell voltage results in storage of energy associated with the BMFC. This could be explained by the update and storage of electrons in the anode biofilm, possibly in the form of high energy storage compounds (e.g., lipids & polysaccharides), which some marine sediment microorganisms can do.

FIG. 2 provides data from a BMFC under two conditions: the solid line shows charging current during the day and discharging current at night during a 50-hour time period when the solar panel was connected to the circuit to charge the BMFC during the day, and the dashed line shows current during a different 50-hour time period when the solar panel was disconnected from the circuit such that the BMFC was at open circuit and thus not recharged during the day, but still discharged at night. Positive values indicate discharging current, negative values indicate charging current) during sequential day (charging) and night (discharging) cycles. This shows the resulting increase in BMFC current when the BMFC stores solar energy.

### DETAILED DESCRIPTION

### Definitions

Before describing the present invention in detail, it is to be understood that the terminology used in the specification is for the purpose of describing particular embodiments, and is not necessarily intended to be limiting. Although many methods, structures and materials similar, modified, or equivalent to those described herein can be used in the practice of the present invention without undue experimentation, the preferred methods, structures and materials are described herein. In describing and claiming the present invention, the following terminology will be used in accordance with the definitions set out below.

As used herein, the singular forms “a”, “an,” and “the” do not preclude plural referents, unless the content clearly dictates otherwise.

As used herein, the term “and/or” includes any and all combinations of one or more of the associated listed items.

As used herein, the term “about” when used in conjunction with a stated numerical value or range denotes somewhat more or somewhat less than the stated value or range, to within a range of ±10% of that stated.

### Overview

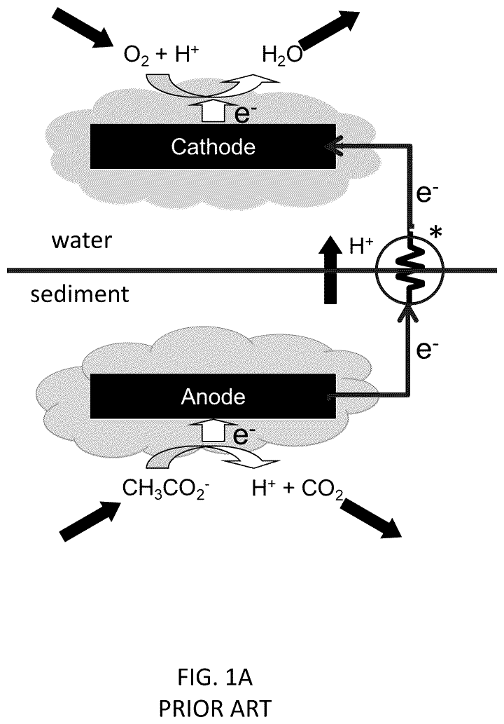

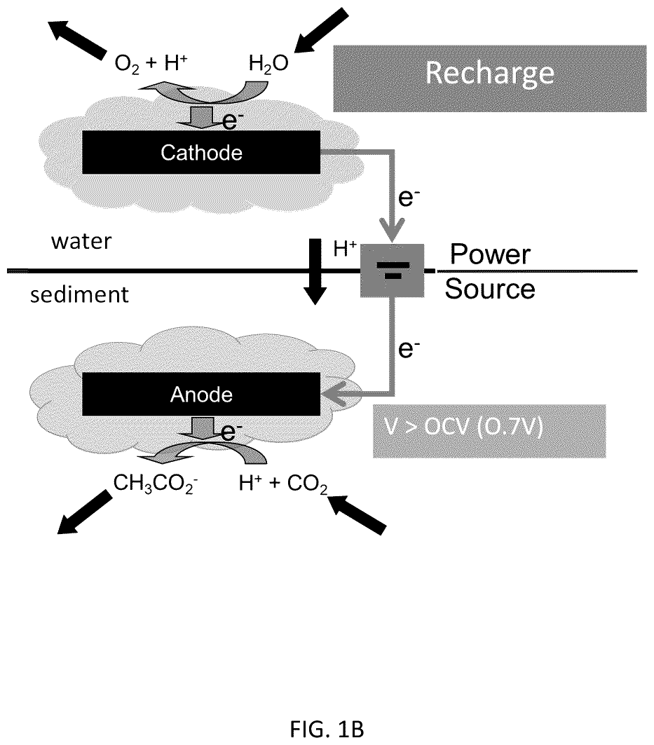

Thus far, BMFCs have been operated in discharging mode, whereby the BMFC draws upon fuel and oxidant naturally residing at the benthic interface to deliver electrical power (FIG. 1A). But, as now described herein, a BMFC can used to store electrical power by operating in reverse (FIG. 1B). That is, if a reverse voltage is applied between the BMFC anode and cathode (opposite to the polarity when a BMFC is being used in conventional discharging mode to supply energy) that is larger than the open circuit cell voltage, thereby applying power to the BMFC (like recharging a battery), then current would flow in the reverse direction with electrons sourced from the cathode and delivered to the anode. When operated in this charging mode, it is hypothesized that the anode biofilm takes up and stores the electrons, possibly in the form of energy storage compounds (such as lipids and polysaccharides), which some marine sediment microorganisms can do. Regardless of the mechanism, it was found that this resulted in energy storage associated with the BMFC. Then, when the BMFC is switched to operating in its normal discharging mode, by connecting it to an external power consuming circuit, the power output from oxidation of sediment fuel would be supplemented by the release of electrons from the energy storage that occurred compounds formed while charging. In this way, in addition to delivering electrical energy, the BMFC could also store electrical energy for later delivery.

For instance, a moored buoy (such as a sensor and/or illuminated marker) incorporating a BMFC and a solar power source can store excess solar-generated energy during the day for utilization at night, thereby reducing the need for batteries on board the buoy resulting in a smaller buoy with reduced need for servicing.

### Examples

A BMFC external circuit using solar panels of an oceanographic buoy for charging a BMFC and a potentiostat for discharging the BMFC was deployed in a 16-ft diameter×4-ft tall marine sediment/seawater filled pool used to replicate the benthic interface for BMFC development. The open circuit cell voltage of the BMFC was 0.7 V. The circuit was designed to charge the BMFC at 1 V while the solar panels were illuminated by sunlight, and discharge the BMFC at 0.4 V at night when the solar panel was not generating power. The solar panel could be disconnected from the circuit, so that, alternatively, the BMFC would be left at open circuit at night as opposed to charging.

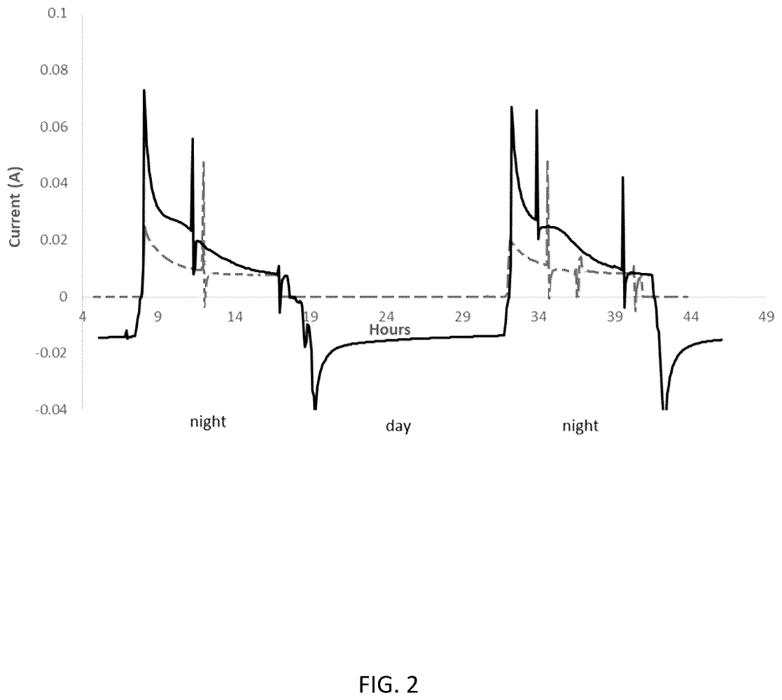

FIG. 2 depicts the resulting BMFC current (positive values indicate discharging current, negative values indicate charging current) during sequential day (charging) and night (discharging) cycles. The solid line traces charging current during the day and discharging current at night during a 50-hour time period when the solar panel was connected to the circuit such that the BMFC was charged during the day. The dashed line traces current during a different 50-hour time period when the solar panel was disconnected from the circuit such that the BMFC was at open circuit and thus not recharged during the day, but still discharged at night. Comparing the two current traces indicates that the discharging current is larger when the solar panel is used to recharge the BMFC than not. As the integral of current vs. time is charge and charge multiplied by voltage (0.4 V used here when discharging), comparing the areas under the currents for the two cases indicates that for this embodiment of the invention, the BMFC delivered 2-fold more energy when discharged following charging then when not charged. The additional energy is attributed to energy stored by the BMFC during charging by a yet to be determined mechanism.

These results were qualitatively replicated by a BMFC deployed in shallow-water coastal environment near Key West, Fla. For that field demonstration, a potentiostat was used to alternate between charging the BMFC at 1 V for 12 hours and discharging the BMFC at 0.4 V for 12 hours.

For a BMFC operated normally (i.e., without recharging) the observed transient shape of the discharging current (dashed curve) is expected and attributed to an initial decrease in amount of BMFC fuel near the anode biofilm due to its consumption by the anode biofilm. Current eventually levels off as the rate of fuel consumption matches fuel supply by mass transport through the sediment. When the BMFC is placed at open circuit, so that it neither is charged nor discharged (dashed curve), fuel near anode biofilm is replenished by mass transport, resulting in a current transient during the next discharge cycle. For the case of the BMFC that was alternated between charging and discharging cycles (solid curve), current transients are observed for both the charging and discharging currents, which may indicate mass transport limited steps in charging of a BMFC and mass transport limited steps in discharging of the resulting stored energy. Regardless, the results depicted in FIG. 2 demonstrates that the charging cycle successfully stored energy associated with the BMFC, which was later released during the discharge cycle.

### Further Embodiments

In certain aspects, the BMFC can include one or more ancillary electrical components such as a potentiostat, sensor, charge controller, voltage regulator, and the like.

### Concluding Remarks

All documents mentioned herein are hereby incorporated by reference for the purpose of disclosing and describing the particular materials and methodologies for which the document was cited.

Although the present invention has been described in connection with preferred embodiments thereof, it will be appreciated by those skilled in the art that additions, deletions, modifications, and substitutions not specifically described may be made without departing from the spirit and scope of the invention. Terminology used herein should not be construed as being “means-plus-function” language unless the term “means” is expressly used in association therewith.

What is claimed is:

1. A benthic microbial fuel cell (BMFC) comprising:
an anode electrode assembly in contact with aquatic sediment;
a cathode electrode in seawater above the sediment;
a rig for maintaining relative positions of the anode electrode assembly and the cathode electrode;
electrical leads extending from the anode electrode assembly and the cathode electrode; and
a power source operably connected to the leads and configured to apply a voltage causing electrons to flow from the cathode to the anode, thereby resulting in the storage of energy associated with the BMFC,
wherein the power source obtains energy via solar power source, wind power, and/or wave power.

2. The BMFC of claim 1, configured as an oceanographic mooring.

3. The BMFC of claim 1, without a conventional battery.

4. The BMFC of claim 1, comprising a sensor.

5. A method of charging a benthic microbial fuel cell (BMFC), the method comprising:
providing a BMFC comprising an anode electrode assembly in contact with aquatic sediment, a cathode electrode in seawater above the sediment, a rig for maintaining relative positions of the anode electrode assembly and the cathode electrode, electrical leads extending from the anode electrode assembly and the cathode electrode, and a power source operably connected to the leads and configured to apply a voltage causing electrons to flow from the cathode to the anode, thereby resulting in the storage of energy associated with the BMFC, wherein the power source obtains energy via solar power source, wind power, and/or wave power; and
applying energy to the BMFC via the power source, thereby storing energy associated with the BMFC.

6. The method of claim 5, wherein the BMFC is configured as an oceanographic mooring.

7. The method of claim 5, wherein the BMFC is without a conventional battery

8. The method of claim 5, wherein the BMFC further comprises a sensor.
